(19) United States
(12) Patent Application Publication
(10) Pub. No.: US 2013/0021226 A1
(43) Pub. Date: Jan. 24, 2013

(54) WEARABLE DISPLAY DEVICES

(71) Applicant: Jonathan Arnold Bell, Long Beach, CA (US)

(72) Inventor: Jonathan Arnold Bell, Long Beach, CA (US)

(21) Appl. No.: 13/555,089

(22) Filed: Jul. 21, 2012

Related U.S. Application Data
(60) Provisional application No. 61/510,185, filed on Jul. 21, 2011.

(51) Int. Cl. G09G 5/00

(52) U.S. Cl. 345/8

(57) ABSTRACT

A wearable display device is described that allows the image from a semi-transparent display screen placed close to the eye to be correctly focused onto the retina while simultaneously allowing the image from the external environment to pass through the device without significant aberration. Focus of the display screen image is achieved through use of a micro-lens array between the screen and the eye, and a separate set of micro-lens arrays on the distant side of the screen in conjunction with the micro-lens array on the near side of the screen allows the external environmental image to pass through. In this manner images from the display screens can overlay the eye's usual view of the external environment. Use of micro-lens arrays that have dynamically adjustable focus properties allow for simulated three-dimensional images and corrective optics for far- or near-sightedness.

### CROSS-REFERENCE TO RELATED APPLICATION

This application claims priority to U.S. Provisional Patent Application Ser. No. 61/510,185 to Jonathan Arnold Bell Entitled “Wearable Display Devices”.

### BACKGROUND OF THE INVENTION:

Previous inventions relating to wearable display devices and head mounted displays (HMDs) have used bulk optics such as lenses, mirrors, prisms, beam splitters, and polarizers to achieve a partially see-through mechanism. Due to the relatively large size of these individual components the complete systems are generally large and heavy. Other efforts use integrated optics such as waveguides, grating structures, and Fresnel lenses to reduce size and weight. U.S. Pat. No. 5,499,138 by Iba (1996) shown in FIG. 1(a) introduces the concept of a micro-lens array to focus the light from a display screen located directly in front of the eye as a means to reduce the bulk of the lens structure and improve the optical clarity of the focused image but makes no mention of a mechanism that would allow the wearer to simultaneously view the display screen image and see through it to the outside environment. U.S. Pat. No. 5,883,606 by Smoot (1999) shown in FIG. 1(b) continues the use of a micro-lens array to focus the display screen image to the eye but uses a different type of display screen from Iba. U.S. Pat. No. 7,318,646 B2 by Bernard et al (2008) shown in FIG. 1(c) achieves a see-through mechanism by sparsely populating individual light emitting pixel elements over a transparent surface with a micro-lens for each pixel. While this allows a relatively clear view through the device, the display screen image resolution is very much reduced and may not be sufficient to produce a high resolution screen image suited to full motion video. U.S. Pat. No. 7,667,783 B2 by Hong et al (2010) shown in FIG. 1(d) incorporates dynamically adjustable micro-lens arrays to focus images from a curved display screen but makes no mention of a mechanism that would allow the wearer to simultaneously view the display screen image and see through it to the outside environment. Therefore, a mechanism is required that allows for both high resolution display screen images focused to the eye(s) and simultaneously allows an aberration-free view through the screen to the outside environment.

### OBJECTS OF THE INVENTION

One object of the present invention is to provide a design for a wearable display device that allows the image from a semi-transparent display screen placed close to the eye to be correctly focused onto the retina while simultaneously allowing the image from the external environment to pass through the device without significant aberration.

A further object of the invention is to provide a design for a wearable display device that can project simulated three-dimensional images to the wearer.

A further object of the invention is to provide a design for a wearable display device that can overcome any far- or near-sightedness present in the wearer.

A further object of the invention is to provide a design for a wearable display device that can project the display screen image at different focal distances.

A further object of the invention is to provide a design for a wearable display device that can project different parts of the display screen image at different focal distances simultaneously.

A further object of the invention is to provide a design for a wearable display device that can magnify objects at near distance and telescopically magnify objects at far distance.

A further object of the invention is to provide a design for a wearable display device that can automatically control the contrast between the displayed screen image and the image of the external environment.

A further object of the invention is to provide a design for a wearable display device that can detect eye ball motion, blinking, eye lens strength, and pupil dilation of the wearer.

A further object of the invention is to provide a design for a wearable display device that can detect images of the external environment in various wavelength bands and estimate relative distances of various objects in view.

### BRIEF DESCRIPTION OF THE DRAWINGS:

FIGS. 1(a), 1(b), 1(c), and 1(d) show examples of prior art related to the invention of wearable display devices.

FIGS. 2(a), 2(b), 2(c), 2(d), 2(e), 2(f), 2(g), and 2(h) illustrate the relationship between prior art and some of the preferred embodiments of the present invention.

FIGS. 3(a), 3(b), 3(c), 3(d), and 3(e) provide a schematic representation of different types of display screens.

FIGS. 4(a), 4(b), 4(c), 4(d), 4(e), and 4(f) provide a schematic representation of different types of optical lenses.

FIGS. 5(a), 5(b), and 5(c) are optical path diagrams showing a technique for focusing a very near image projected from a display screen onto the eye and simultaneously allowing the image of an external environment beyond the display screen to pass through without optical aberration.

FIG. 6 is an optical path diagram showing a technique for bending light emitted from the edges of a flat display screen to the pupil of the eye by offsetting symmetric micro-lenses from the centers of the display screen pixels.

FIG. 7 is an optical path diagram showing a technique for bending light emitted from the edges of a flat display screen to the pupil of the eye by using asymmetric micro-lenses centered on the display screen pixels.

FIG. 8 is an optical path diagram showing a technique for bending light from each sub-pixel of a display screen.

FIG. 9 is an optical path diagram showing a technique for bending light from multiple locations within each sub-pixel of a display screen.

FIG. 10 provides a schematic representation of two display screens arranged as a pair of eye glasses.

FIGS. 11(a), 11(b), 11(c), 11(d), and 11(e) provide a schematic representation of dynamically adjustable optical micro-lenses.

FIGS. 12(a), 12(b), and 12(c) provide a schematic representation of adjustable optical micro-lenses being used to dynamically change the focal distance of the entire display screen image.

FIGS. 13(a), 13(b), 13(c), and 13(d) provide a schematic representation of adjustable optical micro-lenses being used to dynamically change different parts of the display screen image to be at different focal distances.

FIGS. 14(a), 14(b), and 14(c) provide a schematic representation of an adjustable shade being used to dynamically control the brightness of an external environmental image passing through the display screen.

FIG. 15 provides a schematic representation of photo-detector arrays placed on either side of the display screen.

FIGS. 16(a), 16(b), and 16(c) provide a schematic representation of a display pixel size and shape compared to a micro-lens size and shape.

FIG. 17 is an optical path diagram showing a method for enabling a curved wearable display device.

FIGS. 18(a), 18(b), and 18(c) provide a schematic representation of a wearable display device with positioning of display control electronics, wireless transceiver, and a battery.

FIGS. 19(a) and 19(b) provides a schematic representation of a wearable display device connected to control electronics e.g., a cell phone, or a electro-mechanical connector.

FIG. 20 is a photograph of a wearable aperture device.

FIG. 21 is a photograph of a close-up view through a limited number of apertures of the wearable aperture device.

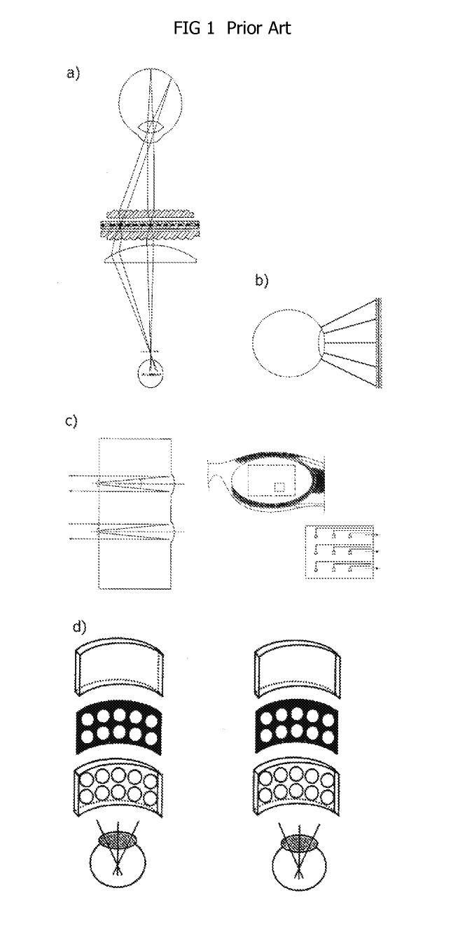

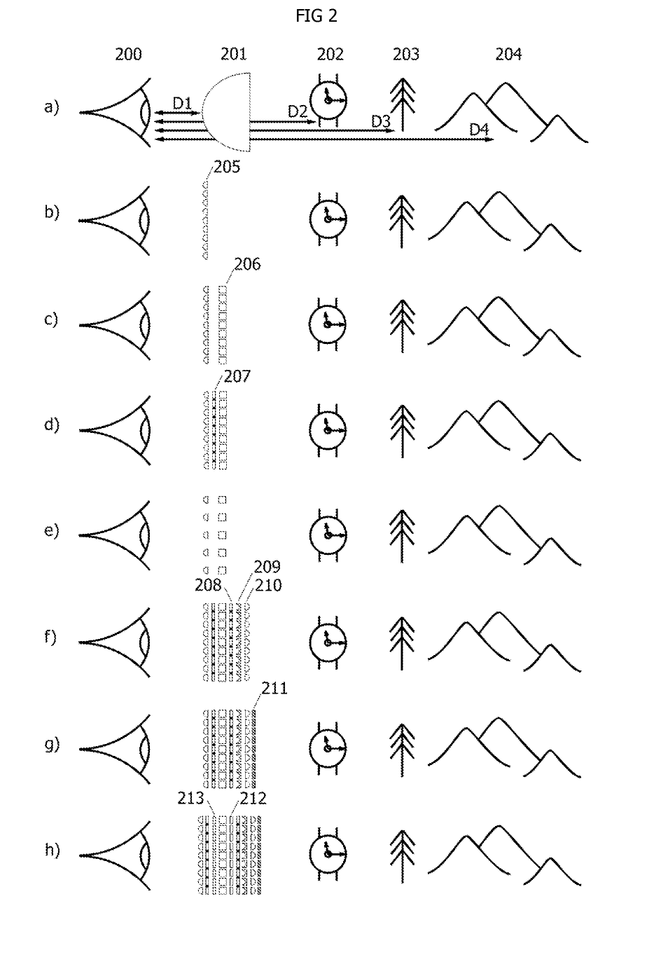

All optical path diagrams shown are approximate, in some case are exaggerated, and are not intended to be exact but meant to illustrate the concepts involved.

### DETAILED DESCRIPTION OF THE INVENTION:

As a means of introduction to the subject of wearable display devices, FIG. 2(a) illustrates a typical bulk convex lens optic 201 placed at a close distance D1 to the eye 200 for purposes of correcting far-sightedness so that an object such as a wrist watch 202 near to the eye at a distance D2 can be focused correctly to the eye. For near-sightedness, convex lens 201 would be replaced with a concave lens so that objects such as mountains 204 far from the eye at a distance D4 can be focused correctly to the eye. A tree 203 at a middle distance D3 may or may not require any corrective lens 201 for proper focusing. If a convex lens 201 is used in a pair of eye glass frames then the convex surface distance D1 may be as close as 0.5 inches from the pupil of the eye 200, the wrist watch 202 may be at a distance D2 of 2 feet, the tree 203 may be at a distance D3 of 10 feet to 100 feet, and the mountains 204 may be at a distance D4 of 1,000 feet to 10,000 feet. FIG. 2(b) illustrates how the bulk lens 201 may be replaced with an array of micro-lenses 205 that perform the same optical function. FIG. 2(c) places a display screen 206 comprised of individual pixels on one side of the micro-lens array such that an image emitted or reflected from the display screen is focused to the eye by the micro-lenses array but using a thickness of lens much reduced from the bulk lens. If the display screen is semi-transparent then an image of the external environment (wrist watch, tree, and mountains) may pass through the display screen and micro-lens array. However, because the required lens power (diopters) of the micro-lens array to focus the display screen image to the eye is typically larger than that of a convex lens to correct far-sightedness, an image of the external environment passing through the micro-lens array will appear distorted at the eye. In short, the wearer of such a device would be able to see the display screen image clearly but not a street they may be walking along. FIG. 2(d) introduces an array of apertures 207 to the mechanism to aid in preventing stray light from neighboring pixels producing aberrations of the screen image at the eye and this approximately represents the designs of Iba and Smoot if the display screen is opaque and does not allow an image of the external environment to pass through the display screen. This is sometimes referred to as an immersive wearable display device. FIG. 2(e) removes apertures and most display pixels and micro-lenses so that the overall device is semi-transparent and does allow an image of the external environment to pass through the display screen and this arrangement is representative of the design of Bernard et al. However, the display screen image resolution is very much reduced and may not be sufficient to produce a high resolution screen image suited to full motion video. FIG. 2(f) introduces an array of concave micro-lenses 209 and an array of convex micro-lenses 210 to the distant surface from the eye of a semi-transparent display screen and represents one of the preferred embodiments of this application. The addition of these micro-lens arrays in conjunction with the micro-lens array on the near side of the display screen allows both a display screen image and an image of the external environment to be simultaneously focused correctly at the eye without substantial aberrations of either image. An array of micro-apertures 208 may aid in preventing stray light from neighboring micro-lenses producing aberrations of an external environment image at the eye. FIG. 2(g) represents a further preferred embodiment of this application where a shading mechanism 211 is incorporated to allow the brightness of the external image passing through the display screen to be adjusted so that an acceptable contrast between the brightness of a display screen image and the brightness of an external image can be maintained. By way of example, shading mechanisms may use adjustable liquid crystals, adjustable photo-chromic, or static neutral density filters. Individual pixel control of the shading mechanism 211 is indicated in FIG. 2(g) although a single shade that covers the entire display area may be acceptable. FIG. 2(h) represents a further preferred embodiment of this application where a photo-detector array 213 is incorporated on the eye side of the display screen to detect eye ball motion, blinking, and pupil dilation. A photo-detector array 212 facing away from the viewer may extract images of the external environment in various wavelength bands and estimate relative distances of various objects in view. FIG. 2 shows a lens, lens apparatus, or display apparatus at a distance D1 from the eye. D1 is defined as the distance from the lens, lens apparatus, or display apparatus to the lens of the human eye. In some embodiments D1 is less than 12 inches. In some embodiments D1 is less than 6 inches. In some embodiments D1 is less than 3 inches. In some embodiments D1 is less than 1 inch. In some embodiments D1 is less than one focal length of the eye.

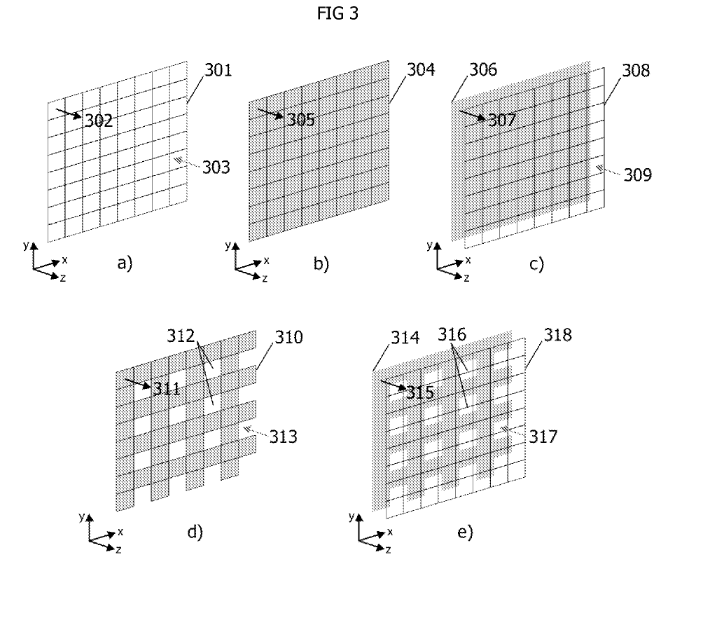

As a means of introduction to display screen technologies, FIG. 3(a) illustrates an example of an 8 by 8 pixel array display screen 301 where each pixel can be individually addressed and controlled. The pixel array is shown in the x-y plane as indicated by the geometrical x-y-z axis. Light emitted from each pixel is predominantly in the z direction as indicated by the arrow 302. The display screen also allows ambient light to pass through the pixels in both directions as indicated by arrows 302 and 303, for example a display that uses transparent organic light emitting diode (TOLED) technology. It is therefore possible for an eye on one side of the screen to see through to the opposite side. FIG. 3(b) shows an example of an 8 by 8 pixel array display screen 304 where each pixel can be individually addressed and controlled. The pixel array is shown in the x-y plane as indicated by the geometrical x-y-z axis. Light emitted from each pixel is predominantly in the z direction as indicated by the arrow 305. The display screen does not allow ambient light to pass through the pixels, for example a display that uses electro-luminescent (EL) or electro-phoretic (EP) technology. It is therefore not possible for a human eye on one side of the screen to see through to the opposite side. FIG. 3(c) shows an example of an 8 by 8 pixel array display screen comprised of a backlight 306 and an 8 by 8 shutter array 308 where each shutter can be individually addressed and controlled, for example, a shutter that uses liquid crystal display (LCD) technology. The pixel array is shown in the x-y plane as indicated by the geometrical x-y-z axis. Light emitted from each pixel is predominantly in the z direction as indicated by the arrow 307. The display screen does not typically allow ambient light to pass through the backlight, for example a display that uses light emitting diode (LED) or cold cathode fluorescent (CCFL) backlight technology. It is therefore not possible for an eye on either one side of the screen to see through to the opposite side. A TOLED backlight would allow a human eye on one side of the screen to see through to the opposite side. FIG. 3(d) shows an example of an 8 by 8 pixel array display screen 310 of the type described in FIG. 3(b) where one in every four pixels has been removed 312 so that ambient light may now pass through the display in both directions 311 and 313 at the positions of the openings 312. FIG. 3(e) shows an example of an 8 by 8 pixel array display screen 314 and shutter array 318 of the type described in FIG. 3(c) where one in every four pixels has been removed 316 so that ambient light may now pass through the display in both directions 315 and 317 at the positions of the openings 316. Other display screen technologies such as electro-wetting, plasma, micro-mirrors, and others may be suited to this application but are not further discussed here for the purposes of brevity.

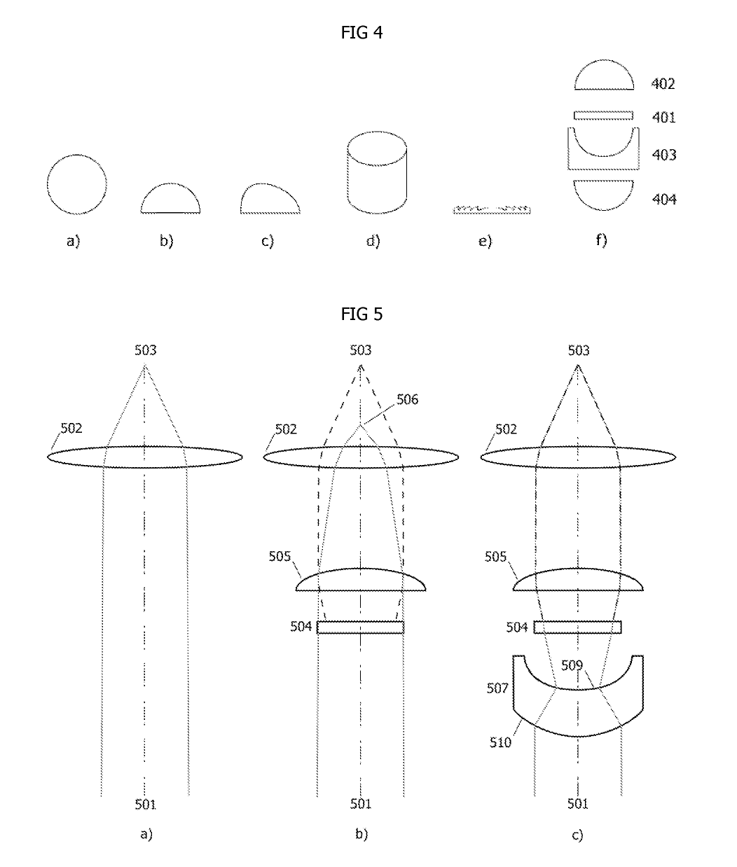

As a means of introduction to optical lens technologies, FIG. 4 shows examples of passive lenses that could be used to perform the correct directing and focusing function for each pixel of the display screen. Passive lenses have a focal length that is fixed and cannot be changed after manufacture. FIG. 4(a) shows a spherical ball lens, FIG. 4(b) shows a half-sphere lens, FIG. 4(c) shows an asymmetric lens, FIG. 4(d) shows a gradient index (GRIN) lens, FIG. 4(e) shows a Fresnel lens, and FIG. 4(f) shows a multi-lens arrangement suitable for transparent display screens. Light emitted from the display screen pixel 401 is focused to the eye using convex lens 402. When the pixel is transparent, ambient light may travel through the pixel 401 and convex lens 402. The convex lens 402 will tend to distort the ambient image. To offset the undesired distortion a concave lens 403 and convex lens 404 is placed behind the display screen pixel. To minimize the thickness of any lens plus pixel plus lens arrangement, it is important to have the lenses placed close to the surface of the pixel without a substantial air gap. Using lens arrangements that lie on either side of the pixels with no air gap between them is ideal for minimizing thickness. Because the lenses are so close to the pixels it is important to compensate for the magnification of the lens so that each magnified pixel perceived at the eye does not substantially overlap adjacent magnified pixels.

Lenses and display screens may now be combined and FIG. 5 shows an example of optical ray tracing through a multi-lens and display pixel arrangement. FIG. 5(a) shows a ray of light from a distant object 501 focused by the lens of the eye 502 onto the retina 503. FIG. 5(b) adds a display screen pixel 504 and convex lens 505 close to the eye. The convex lens focuses the pixel light onto the retina (dashed line). As a result, a ray of light from the distant object (solid line) is no longer focused properly on the retina 503. FIG. 5(c) adds a compensating lens 507 with convex surface 510 and concave surface 509 to refocus a ray of light from the distant object properly onto the retina. In this manner, micro-lens arrays may be used to correctly focus a multi-pixel display screen image placed in close proximity to the eye and simultaneously allow an image of the external environment to pass through the device substantially unaltered.

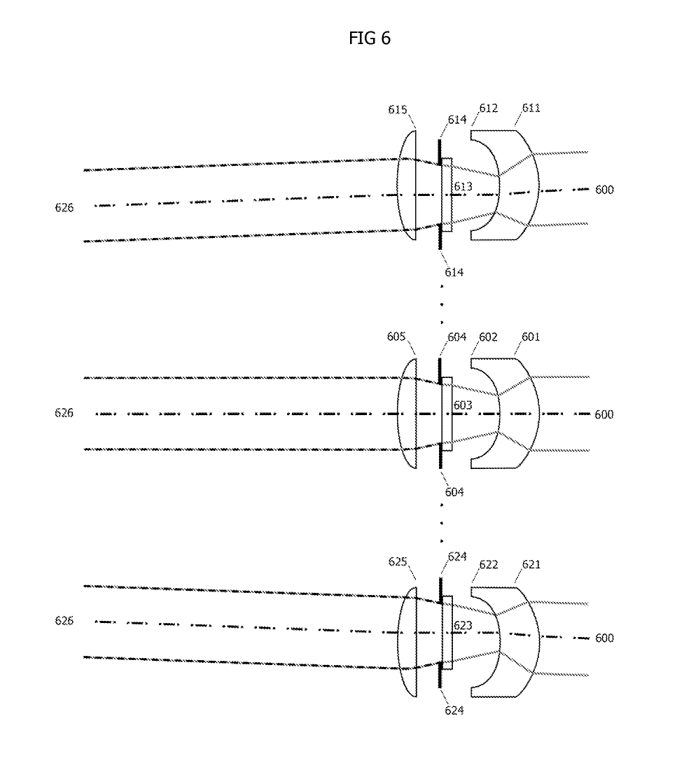

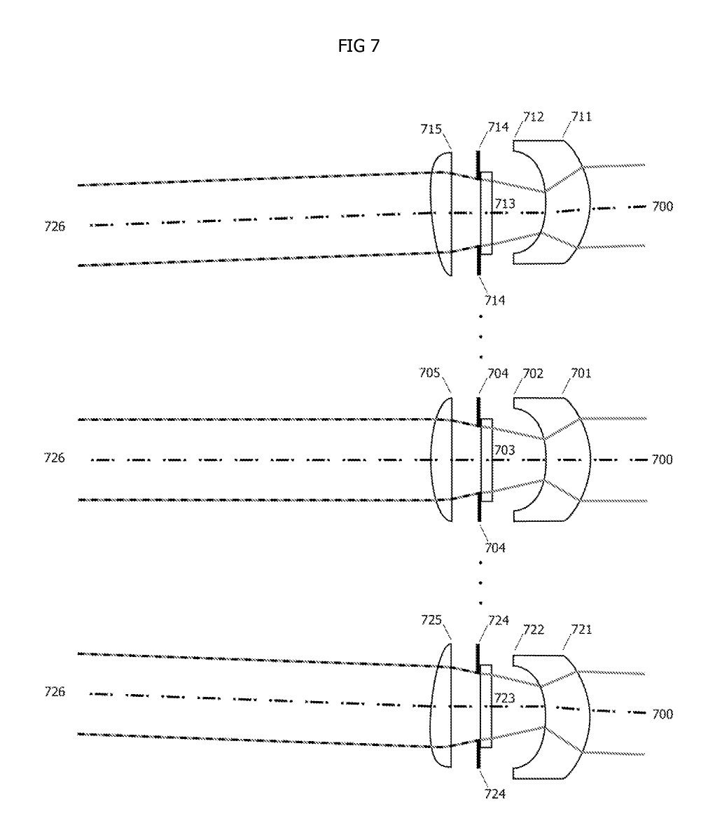

If the display screen is predominantly flat or not matched to the curvature of the eye then light emitted, reflected, or passing through each pixel of the display screen will require a slightly different micro-lens function at each pixel to bend the rays of light by an appropriate amount. FIG. 6 shows an example where a central area of the display screen allows light rays from a distant object 600 (solid line) to be focused by micro-convex lens 601, defocused by micro-concave lens 602, pass through display screen pixel 603 and aperture 604 and be focused by micro-convex lens 605 to the eye lens 626. Simultaneously light emitted or reflected from the display screen pixel 603 (dashed line) passes through aperture 604 and is focused by micro-convex lens 605 to the eye lens 626. For display screens of relatively large size compared to the pupil of the eye then display pixel areas that lie towards the upper, lower, left or right hand sides of the display screen require additional light ray bending compared to those in the center. FIG. 6 illustrates this by micro-lenses 615 and 625 offset from the centers of their respective display pixels to produce the appropriate bending function. A similar bending technique can be achieved using asymmetrical micro-lenses 715 and 725 as shown in FIG. 7.

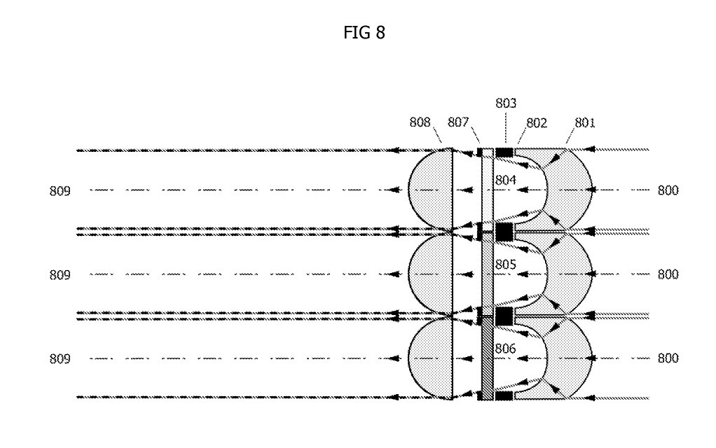

Color display screens typically have each pixel divided into three sub-pixels, one for red, one for green, and one for blue colors. When all sub-pixels are illuminated at equal brightness then a white color can be evoked. FIG. 8 illustrates a design where each sub-pixel, red 804, green 805, and blue 806 has its own set of micro-lenses associated with it. For brevity only the rays passing through the red sub-pixel will be described. Light rays from a distant object 800 (solid line), pass through the convex micro-lens 801 and concave micro-lens 802. Stray light is prevented from passing to a neighboring sub-pixel by aperture 803. The light passes through the sub-pixel 804 to convex micro-lens 808 that focuses to the eye lens 809. Light emitted or reflected from the display sub-pixel 804 also passes to convex micro-lens 808 that focuses to the eye lens 809. Stray light from the sub-pixel or from the external environment is prevented from passing to a neighboring sub-pixel by aperture 807. One potential advantage of this arrangement is that having micro-lens arrays where individual micro-lenses are designed specifically for a band of red, or green, or blue wavelengths will likely reduce the chromatic aberrations that occur when compared to a single micro-lens that focuses all visible wavelengths simultaneously. A second potential advantage of this arrangement is that having three micro-lenses per display pixel instead of one allows the external environmental image to be fragmented into a three times higher resolution before being recombined at the eye. It should be noted that micro-lenses 808 can be designed to allow light from each sub-pixel to overlap at the eye.

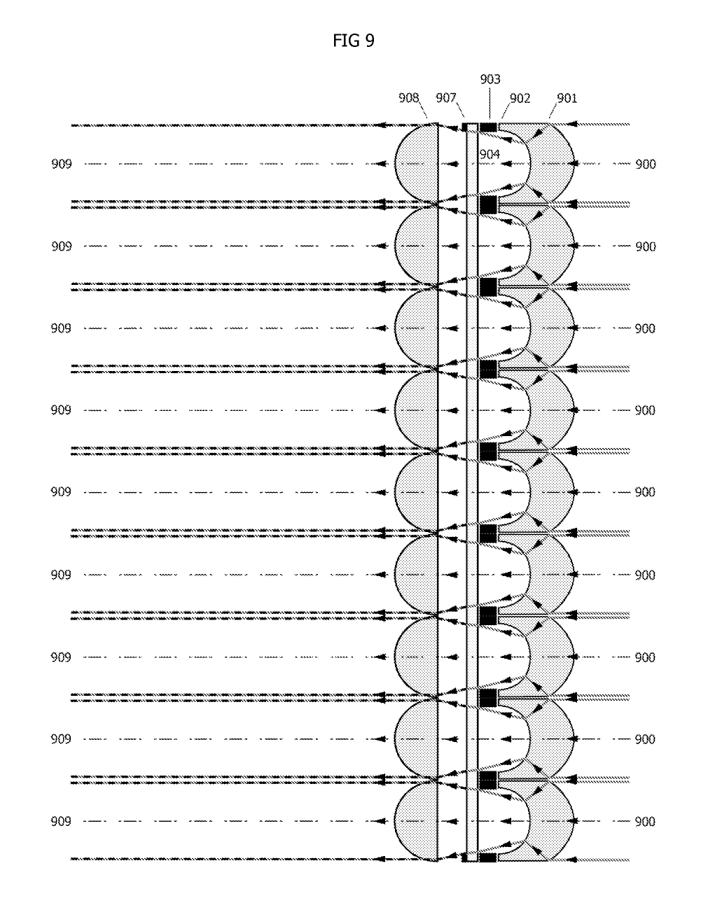

Resolution of the external environmental image compared to the resolution of the display screen is an important issue. While no exact measure of the eye's resolution capabilities are available, it may be considered that it is as high as 10,000 dots per inch. Standard display screen technologies such as those used in cell-phones as of 2012 typically use resolutions of 300 pixels per inch. When a screen of 300 pixels per inch is held at approximately one inch from the eye and focused using a magnifying glass lens, the sub-pixels can easily be seen. It is therefore desirable to increase the display screen resolution to more than 300 pixels per inch for most applications where display devices are worn close to the eye. More importantly, if the external environmental image is passed through a wearable display device that has 300 micro-lenses per inch, the perceived external image could be noticeably degraded. If a 300 dpi display screen has one micro-lens arrangement per sub-pixel then the device would have 900 micro-lenses per inch. FIG. 9 illustrates a method to increase the lenses per inch by providing each sub-pixel with multiple micro-lens arrangements. Sub-pixel 904 has nine separate micro-lens arrangements shown in profile from the top to the bottom. If sub-pixel 904 were square shaped in nature then it would include eighty-one micro-lens arrangements. It is also worthy of note that as the resolution of the micro-lens arrays increase, the individual micro-lens size naturally decreases. As the size of each micro-lens approaches the wavelengths of visible light, approximately in the 650 nm range for reds and 450 nm for blues and ultra-violets, optical diffraction effects begin to occur. Diffraction causes the light rays to bend in undesirable directions that can cause severe aberrations in the image of the display screen and/or the external environmental image. If the resolving power of the human eye is approximately 10,000 dots per inch at the retina, then micro-lens sizes in the 2500 nm range may allow for high resolution display screen and external environmental images to be maintained without significant diffraction effects (10,000 dots per inch is approximately equivalent to 10,000 dots per 25 mm, or 1 dot per 2500 nm which is significantly larger than the 650 nm to 450 nm wavelength range of visible light and so avoids most diffraction effects).

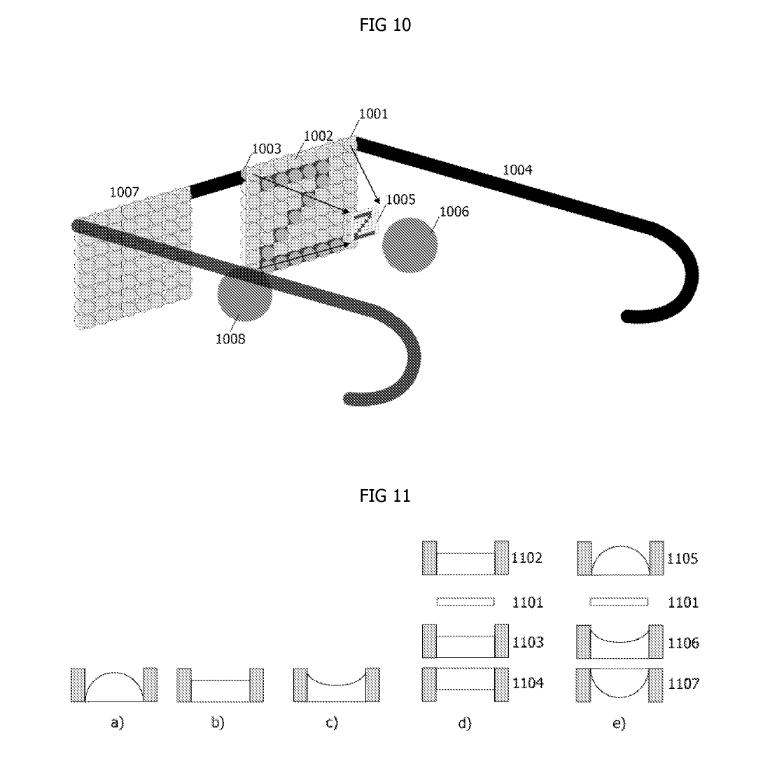

Having defined a display screen and associated micro-lens arrays suitable for use close to the eye, FIG. 10 shows an example of the previously described display devices 1007 implemented within the frame of a set of eyeglasses 1004. Micro-lens arrays 1002 are placed in front of the display screen 1001 to direct and focus the emitted light to a smaller image of the screen 1005 so that a clear picture is formed on the retina of the eye 1006. Micro-lens arrays 1003 on the display screen side furthest from the eye, in conjunction with micro-lens arrays 1002, allow light from the external environment to pass through without substantial aberration. The dual display devices also allow for simulated three-dimensional images to be perceived by the wearer if one image is shown separately to the left eye, and a slightly different image is shown to the right eye. It should be noted that the actual focal distance of the perceived three-dimensional image is static (does not change) and is set by the optical strength of the micro-lens arrays that focus the display screen image to the eye. To dynamically change the actual focal distance of the display screen image it is required to have dynamically controllable micro-lenses.

FIG. 11 shows an example of an active lens arrangement. As opposed to a passive lens arrangement, an active lens may have its directional, focusing, and magnification properties dynamically controlled and changed after manufacture by the user. FIG. 11(a) shows an example of the active lens having a convex shape. FIG. 11(b) shows an example of the active lens having a neutral shape. FIG. 11(c) shows an example of the active lens having a concave shape. Using active lens technologies such as electro-wetting, each micro-lens may be activated to its desired shape only when the pixel is activated. When a pixel is inactive, the lenses can be switched to the desired inactive neutral state that allows an aberration-free image of the external environment to pass through to the eye. At times where all pixels are being used to display an image, then lenses between the screen and the eye will be convex. To allow for simultaneous aberration-free imaging of the external environment and the display image when all display pixels and lenses are activated, an arrangement of compensating active lenses is required on the opposite side of the transparent display (as previously described for passive lenses). FIG. 11(d) shows an active lens 1102 in the neutral state above a pixel area 1101 with two further active lenses in the neutral state 1103, 1104 on the opposite side of the pixel. FIG. 11(e) shows an active lens 1105 in the convex state above a pixel area 1101 with a further active lens in the concave state 1106 and a further active lens in the convex state 1107 on the opposite side of the pixel. It should be possible to control the active lenses using signals derived from the integrated circuits that drive the display screen pixels and sub-pixels.

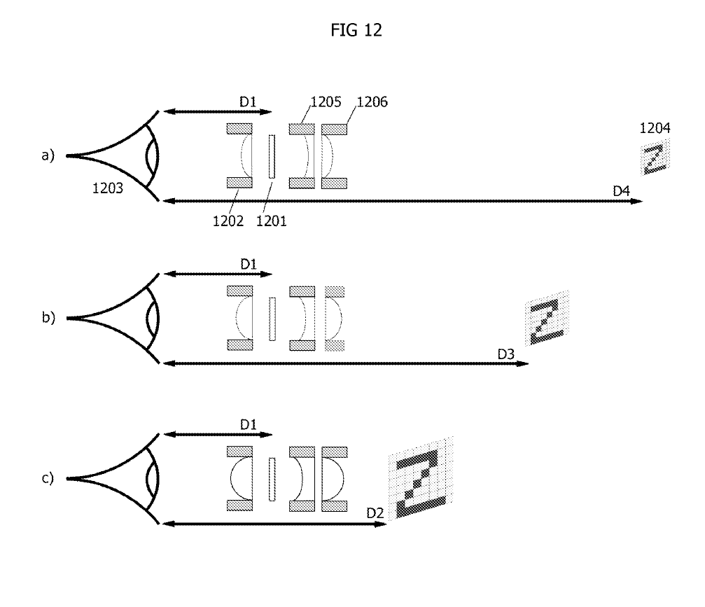

FIG. 12 illustrates how dynamically controllable micro-lenses may be used to change the actual focal distance of the entire display screen image. FIG. 12(a) illustrates that the actual focal distance D4 of the display screen image 1204 is controlled by the display screen distance D1 from the eye 1203 and the curvature of the convex micro-lens 1202. By increasing the curvature of the convex micro-lens, shown in FIG. 12(b), the focal distance D3 becomes shorter and the image appears closer to the eye. By increasing the curvature of the convex micro-lens further, shown in FIG. 12(c), the focal distance D2 becomes even shorter and the image appears even closer to the eye. For the purposes of clarity only one micro-lens arrangement for one single display screen pixel 1201 is shown. It is assumed that all display screen focusing micro-lenses 1202 for all display screen pixels 1201 act in unison to change the actual focal distance of the entire display screen image. Similarly, all compensating micro-lenses 1205 and 1206 may change appropriately to maintain an aberration free image of the external environment.

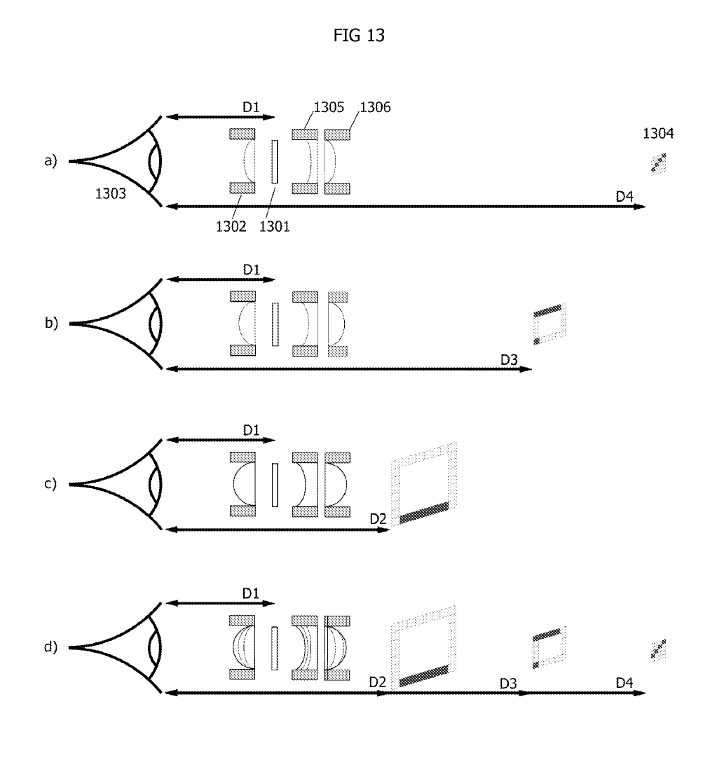

FIG. 13 illustrates how dynamically controllable micro-lenses may be used to change the actual focal distance of different parts of the display screen image simultaneously. FIG. 13(a) illustrates that the actual focal distance D4 of a central part of the display screen image 1304 is controlled by the display screen distance D1 from the eye 1303 and the curvature of the convex micro-lens 1302. It is assumed that all display screen focusing micro-lenses 1302 for all display screen pixels 1301 that form the central part of the display screen image act in unison to change the actual focal distance of the central part of the display screen image. Similarly, all compensating micro-lenses 1305 and 1306 may change appropriately to maintain an aberration-free image of the central part of the external environment. Simultaneously, by increasing the curvature of the convex micro-lens arrays responsible for an inner ring of pixels on the display screen, shown in FIG. 13(b), the focal distance of the image formed by the inner ring of pixels becomes shorter and the image appears closer to the eye. It is assumed that all display screen focusing micro-lenses 1302 for all display screen pixels 1301 that form an inner ring of pixels of the display screen image act in unison to change the actual focal distance of the entire inner ring display screen image. Similarly, all compensating micro-lenses 1305 and 1306 may change appropriately to maintain an aberration free image of an inner ring part of the external environment. Simultaneously, by increasing the curvature of the convex micro-lens arrays responsible for an outer ring of pixels on the display screen further, shown in FIG. 13(c), the focal distance of the image formed by the outer ring of pixels becomes even shorter and the image appears even closer to the eye. It is assumed that all display screen focusing micro-lenses 1302 for all display screen pixels 1301 that form an outer ring of pixels of the display screen image act in unison to change the actual focal distance of the entire outer ring display screen image. Similarly, all compensating micro-lenses 1305 and 1306 may change appropriately to maintain an aberration-free image of the outer ring part of the external environment. FIG. 13(d) is a composite of FIGS. 13(a), 13(b), and 13(c) that illustrates three separate parts of the display screen image simultaneously being set at different actual focal distances whilst maintaining an aberration-free image of the external environment. Adjustable micro-lens arrays may have any individual micro-lens in the array adjusted to control directional, focusing, and magnification properties independent of other micro-lenses in the array.

Two further applications of the adjustable micro-lens arrays are worth noting. One application relates to corrective eye wear. If the concave micro-lens 1305 of FIG. 13(a) is in a partially neutral state then micro-lens 1306, or micro-lens 1302 can be adjusted to correct for far-sightedness of the device wearer as well as performing the previously described tasks of focusing the display screen image and maintaining the external environmental image. Conversely, if the convex micro-lens 1306 and micro-lens 1302 of FIG. 13(a) are in a partially neutral state then concave micro-lens 1305 can be adjusted to correct for near-sightedness of the device wearer as well as performing the previously described tasks of focusing the display screen image and maintaining the external environmental image. When preferred, a separate array of convex micro-lenses can be added to the device to exclusively correct for far-sightedness, and a separate array of concave micro-lenses can be added to the device to exclusively correct for near-sightedness.

A second application relates to magnification of objects. If the concave micro-lens 1305 of FIG. 13(a) is in a partially neutral state then micro-lens 1306 and micro-lens 1302 can be adjusted to provide a telescopic function for the device wearer as well as performing the previously described tasks of focusing the display screen image and maintaining the external environmental image. Convex micro-lens 1306 acts as a magnifying glass to place a virtual image of a distant object at a position between convex micro-lenses 1306 and 1302. Convex micro-lens 1302 then acts as a magnifying glass on the virtual image formed by convex micro-lens 1306 to produce a telescopic image at the eye. Alternatively, if the concave micro-lens 1305 and convex micro-lens 1306 of FIG. 13(a) is in a partially neutral state then convex micro-lens 1302 can be adjusted to provide a magnification function for the device wearer on objects placed very close to the eye as well as performing the previously described tasks of focusing the display screen image and maintaining the external environmental image. When preferred, two separate arrays of convex micro-lenses can be added to the device to exclusively perform telescopic and/or magnification effects and additional arrays added to correct for image inversion.

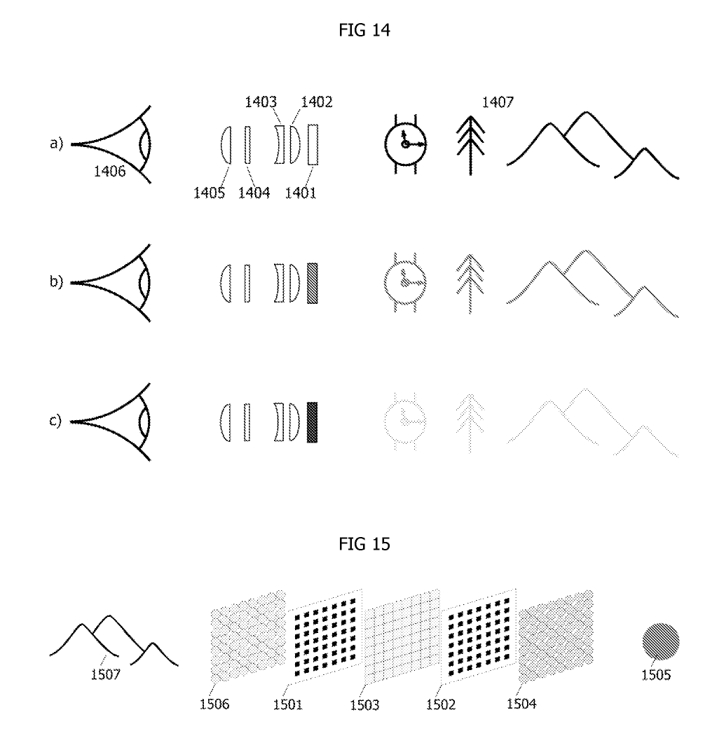

To maintain a clearly visible display screen image overlaid on an image of the external environment it is important to control the relative brightness of both images. Usually the brighter image will dominate over the dimmer image. To achieve a convenient contrast balance between both images it is desirable to place a shading mechanism on one side of the display screen furthest from the eye of the wearer. FIG. 14(a) illustrates an example where the shading device 1401 is in the transmission state and allows most of the light from the external environment 1407 to pass through the shading device and the micro-lens arrays 1402, 1403, 1405, and the display pixels 1404 to the eye 1406. FIG. 14(b) illustrates an example where the shading device 1401 is in a partial transmission state and allows some of the light from the external environment 1407 to pass through to the eye 1406. FIG. 14(c) illustrates an example where the shading device 1401 is in a partial opaque state and allows little of the light from the external environment 1407 to pass through to the eye 1406. For pixels 1404 of an emissive display screen, the brightness of each individual pixel and sub-pixel can usually be individually controlled, or controlled as a whole to adjust brightness of the display screen image. By way of example, shading mechanisms may use adjustable liquid crystals combined with polarizing plates, adjustable photo-chromic screens, or static neutral density filters. Individual pixel control of the shading mechanism 1401 is indicated in FIG. 14(a) although a single shade that covers the entire display area may be acceptable.

A further embodiment of the invention is to provide a design for a wearable display device that can detect eye ball motion, blinking, eye lens diopter strength, and pupil dilation of the wearer. FIG. 15 illustrates an array of photo-detectors 1502 placed between the display screen 1503 and display screen focusing micro-lens array 1504 to achieve this effect. The resolution of the photo-detector array may in this case be significantly less than the number of pixels on the display screen and this is not shown in FIG. 15. Each of the photo-detectors in the array may form only part of the eye image and in an extreme case only one photo-detector comprised of many individual photo-detector elements may serve to capture an image of the eye that can be used to determine tracking of the eye and other previously mentioned attributes. Because photo-detectors usually function by absorbing light incident upon them they are usually considered opaque and therefore potentially block parts of the display screen image and/or the external environmental image from passing through. Reducing the number and size of the photo-detectors can minimize this effect.

A further embodiment of the invention is to provide a design for a wearable display device that can detect images of the external environment in various wavelength bands and estimate relative distances of various objects in view. FIG. 15 illustrates an array of photo-detectors 1501 placed between the display screen 1503 and compensating micro-lens arrays 1506 to achieve this effect. The resolution of the photo-detector array may in this case be significantly less than the number of pixels on the display screen and this is not shown in FIG. 15. Each of the photo-detectors in the array may form only part of the external environmental image 1507 and in an extreme case only one photo-detector comprised of many individual photo-detector elements may serve to capture an image of the external environment in various wavelength bands. Photo-detected images of the external environment can be used to calculate a related display screen image that accurately overlays the image of the external environment. For example, a photo-detected image of a street scene can be analyzed by computer to extract information about edges that define a road, a building, a person, etc. A display screen image can then be calculated to exactly overlay the external image and highlight in line-drawing, alpha-numeric text, video, or some other means, points of interest that exist in the external environmental image. Applications for this capability are numerous and include but are not limited to automobile driving directions, shopping, face recognition, educational instruction and the like. Additionally, photo-detectors may detect in different wavelength bands, either visible or infra-red. Using an array of infra-red photo-detectors at night-time or when the ambient light conditions have low brightness to relay the infra-red image brightness information to the display screen that recreates the external image but with visible light can be highly beneficial for vision in the dark. Because photo-detectors usually function by absorbing light incident upon them they are usually considered opaque and therefore potentially block parts of the external environmental image from passing through them. Reducing the number and size of the photo-detectors can minimize this effect.

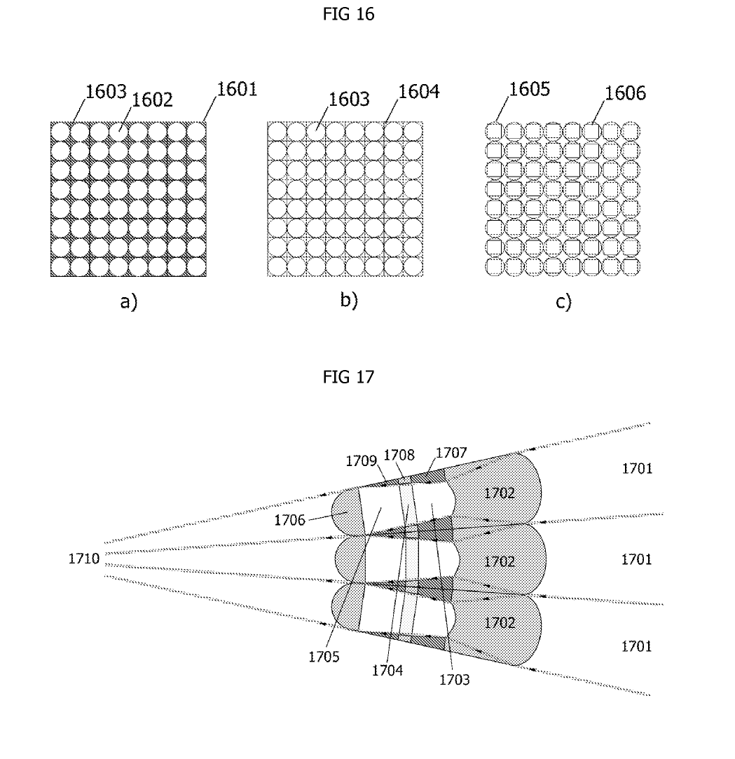

FIG. 16(a) illustrates a front view of circular shaped micro-lenses 1602 positioned on a display screen 1601 with square shaped pixels. It is evident that the micro-lenses do not cover the entire area of the pixels and so some light from the display pixel areas 1603 (darkened regions) may not be focused to the eye or light from a neighboring pixel may stray into the path of an adjacent micro-lens if not apertured appropriately. FIG. 16(b) illustrates a front view of micro-lenses 1603 that are circular in shape at the point most distant from the display pixels but are square shaped at the point closest to the display pixels. In this manner the maximum amount of light from a display pixel may be captured appropriately and focused to the eye. FIG. 16(c) shows a method where the square shaped pixels of the display screen 1606 are smaller than the circular shape of the micro-lenses 1605 and so a maximum amount of light from the display screen is allowed to be focused to the eye. FIG. 16 does not show sub-pixel red, green, and blue arrangements of the display screen which are typically rectangular in shape. Therefore it is apparent that the shape of any micro-lenses required to efficiently focus light from the display screen to the eye across the entire area of the display screen is a complex task complicated further by the need to provide offset or asymmetric micro-lenses of different design across the entire area of the display screen if it is relatively flat compared with the curvature of the eye. Complex designs are also required for the compensating micro-lens arrays on the far side of the display screen from the eye to maintain a correct external environmental image.

A further preferred embodiment of the design in presented in FIG. 17 where the micro-lens arrays are arranged in a curved shape to mimic the shape of the eye. Light rays from a distance 1701 enter the compensating micro-lens arrays 1702, enters the region 1703 and is apertured at 1707, passes through the display pixel 1704, enters the region 1705 and is apertured at 1709, and focused through micro-lens arrays 1706 to the eye 1710. The micro-lens array 1702 that combines both convex and concave lenses is readily fabricated using current molding technology, as are the aperture arrays 1707 and 1709, and micro-lens array 1706. To complete the device a display screen with pixels 1704 and electrical interconnections 1708 must be constructed that is effectively curved in nature, either simple curvature or compound curvature. It may be possible to construct such a screen using contemporary fabrication techniques that are initially flat in nature but can be later folded or compressed into the correct curvature. In this manner the micro-lens designs may be simplified so that they remain essentially the same across the entire area of the display screen.

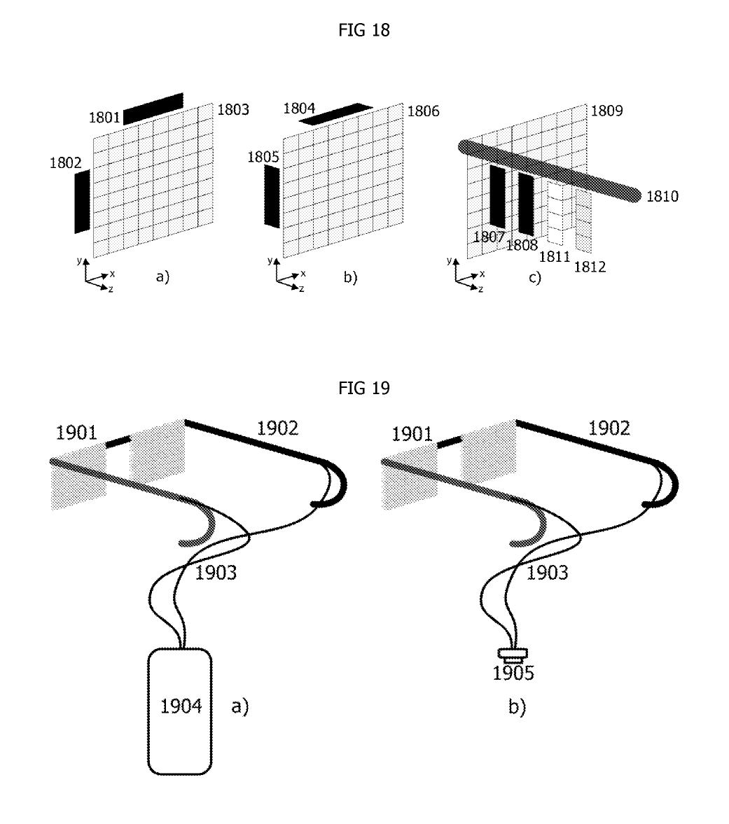

FIG. 18 illustrates examples where the electronic driver circuits for the display screens and lenses could be placed when used in reference to a set of eyeglasses. FIG. 18(a) shows a display screen 1803 with an electronic driver circuit for pixel columns/lenses 1801 for controlling pixels in the x direction placed predominantly in the x-y plane and an electronic driver circuit for pixel columns/lenses 1802 for controlling pixels in the y direction placed predominantly in the x-y plane. FIG. 18(b) shows a display screen 1806 with an electronic driver circuit for pixel columns/lenses 1801 for controlling pixels in the x direction placed predominantly in the x-z plane and an electronic driver circuit for pixel columns/lenses 1805 for controlling pixels in the y direction placed predominantly in the y-z plane. FIG. 12(c) shows a display screen 1809 with an electronic driver circuit for pixel columns/lenses 1807 for controlling pixels in the y direction placed predominantly in the y-z plane and an electronic driver circuit for pixel columns/lenses 1808 for controlling pixels in the x direction placed predominantly in the y-z plane, both drivers located within the side arm of the eyeglasses 1810. Also indicated are positions where a battery power supply 1811 and wireless transceiver 1812 may be located.

FIG. 19(a) shows an example of a pair of display screens and lens arrangements 1901 connected through the side arms of the eyeglasses 1902 by electrical cables 1903 to a control box 1904. The control box may contain electronic circuits and software to drive the display screens and lens arrangements, the electrical power storage necessary, and wired or wireless transceiver circuits for communication with other devices for data transfer. FIG. 19(b) shows an example of a pair of display screens and lens arrangements 1901 connected through the side arms of the eyeglasses 1902 by electrical cables 1903 to a mechanical electrical connector 1904. The connector may couple with a control box that contains electronic circuits and software to drive the display screens and lens arrangements, the electrical power storage necessary, and wired or wireless transceiver circuits for communication with other devices for data transfer. As an example the connector may connect with a cell phone.

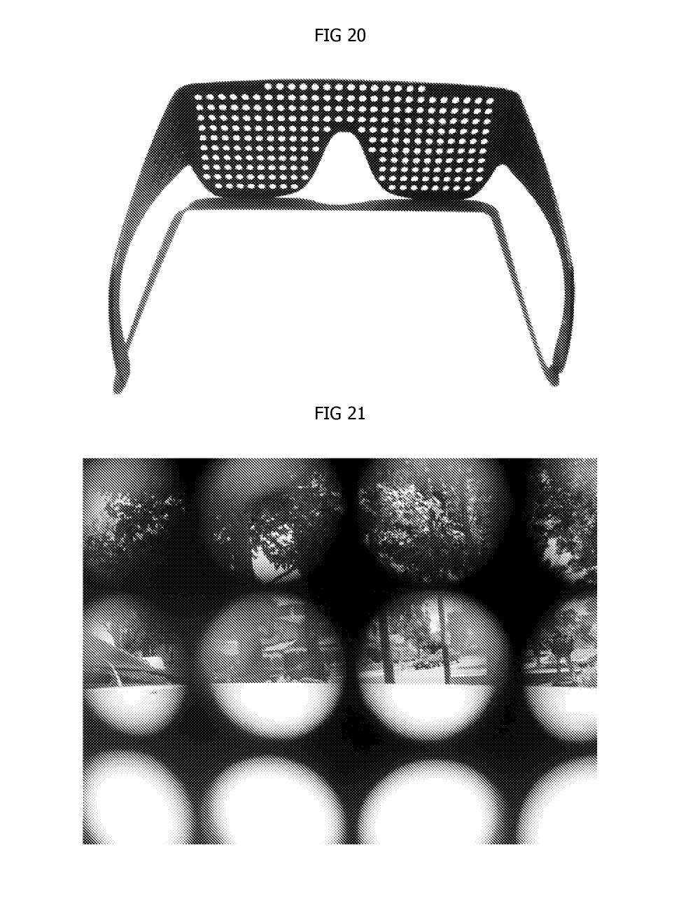

FIG. 20 shows an example of eyewear where only approximately 25% of the eyewear is transparent. This is achieved by drilling a regular array of small aperture openings of 3 mm diameter with a center to center spacing of 5 mm.

FIG. 21 shows an example of the environmental image that can be seen through the small openings of the eyewear when the eye (in this case a camera lens) is approximately 25 mm distant from the eyewear.

1. A display apparatus placed at a distance from a human eye, wherein the distance is less than 12 inches in length from the eye lens, the display apparatus comprising:
a display screen that is semi-transparent to surrounding environmental wavelengths of light having a plurality of pixels and sub-pixels arranged in a first array to produce a display screen image;
a first optical focusing lens placed between the display screen and the eye, wherein the first optical focusing lens has a first plurality of micro-lenses arranged in a second array, and wherein each of the first plurality of micro-lenses has a first focal length to focus the display screen image to the eye;
a second optical focusing lens placed on the distant side of the display screen from the eye, wherein the second optical focusing lens has a second plurality of micro-lenses arranged in a third array and wherein each of the second plurality of micro-lenses has a second focal length to compensate an image of the external environment prior to passing through the display screen and the first optical focusing lens;
and
a third optical focusing lens placed on the distant side of the display screen and the eye, wherein the third optical focusing lens has a third plurality of micro-lenses arranged in a fourth array, and wherein each of the third plurality of micro-lenses has a third focal length to compensate an image of the external environment prior to passing through the display screen and the first optical focusing lens.

2. The display apparatus of claim 1, wherein:
the display screen is flat;
the first optical focusing lens is flat;
the first focal length is fixed;
the second optical focusing lens is flat;
the second focal length is fixed;
the third optical focusing lens is flat;
and
the third focal length is fixed.

3. The display apparatus of claim 1, wherein;
the display screen is curved;
the first optical focusing lens is curved;
the first focal length is fixed;
the second optical focusing lens is curved;
the second focal length is fixed;
the third optical focusing lens is curved;
and
the third focal length is fixed.

4. The display apparatus of claim 1, wherein:
the display screen is flat;
the first optical focusing lens is flat;
the first focal length is adjustable;
the second optical focusing lens is flat;
the second focal length is adjustable;
the third optical focusing lens is flat;
and
the third focal length is adjustable.

5. The display apparatus of claim 1, wherein;
the display screen is curved;
the first optical focusing lens is curved;
the first focal length is adjustable;
the second optical focusing lens is curved;
the second focal length is adjustable;
the third optical focusing lens is curved;
and
the third focal length is adjustable.

6. The display apparatus of claim 2, further comprising a first plurality of apertures placed between the display screen and the optical focusing lens nearest to the eye to prevent optical aberrations.

7. The display apparatus of claim 6, further comprising a second plurality of apertures placed between the display screen and the second optical focusing lens to prevent optical aberrations.

8. The display apparatus of claim 2, further comprising a plurality of photo-detectors placed between the display screen and the second optical focusing lens to detect optical images of the external environment.

9. The display apparatus of claim 2, further comprising a plurality of photo-detectors placed between the display screen and the first optical focusing lens to detect optical images of the eye.

10. The display apparatus of claim 3, further comprising a first plurality of apertures placed between the display screen and the optical focusing lens nearest to the eye to prevent optical aberrations.

11. The display apparatus of claim 10, further comprising a second plurality of apertures placed between the display screen and the second optical focusing lens to prevent optical aberrations.

12. The display apparatus of claim 3, further comprising a plurality of photo-detectors placed between the display screen and the second optical focusing lens to detect optical images of the external environment.

13. The display apparatus of claim 3, further comprising a plurality of photo-detectors placed between the display screen and the first optical focusing lens to detect optical images of the eye.

14. The display apparatus of claim 4, further comprising a first plurality of apertures placed between the display screen and the optical focusing lens nearest to the eye to prevent optical aberrations.

15. The display apparatus of claim 14, further comprising a second plurality of apertures placed between the display screen and the second optical focusing lens to prevent optical aberrations.

16. The display apparatus of claim 4, further comprising a plurality of photo-detectors placed between the display screen and the second optical focusing lens to detect optical images of the external environment.

17. The display apparatus of claim 4, further comprising a plurality of photo-detectors placed between the display screen and the first optical focusing lens to detect optical images of the eye.

18. The display apparatus of claim 5, further comprising a first plurality of apertures placed between the display screen and the optical focusing lens nearest to the eye to prevent optical aberrations.

19. The display apparatus of claim 18, further comprising a second plurality of apertures placed between the display screen and the second optical focusing lens to prevent optical aberrations.

20. The display apparatus of claim 5, further comprising a plurality of photo-detectors placed between the display screen and the second optical focusing lens to detect optical images of the external environment.

21. The display apparatus of claim 5, further comprising a plurality of photo-detectors placed between the display screen and the first optical focusing lens to detect optical images of the eye.

22. The display apparatus of claim 1, further comprising a shading means for adjusting the intensity of ambient light passing through the display apparatus to the eye.

23. A lens apparatus placed at a distance from a human eye, wherein the distance is less than 12 inches in length from the eye lens, and wherein the lens apparatus corrects for imperfections of the eye, the lens apparatus comprising a first optical focusing lens having a first plurality of micro-lenses of a first focal length and first curvature.

24. The lens apparatus of claim 23, wherein the first focal length is static.

25. The lens apparatus of claim 24, wherein first curvature is convex.

26. The lens apparatus of claim 24, wherein first curvature is concave.

27. The lens apparatus of claim 23, wherein the first focal length is adjustable.

28. The lens apparatus of claim 27, wherein first curvature is concave.

29. The lens apparatus of claim 27, wherein first curvature is convex.

30. The lens apparatus of claim 23, further comprising a second optical focusing lens placed a second distance from the human eye, wherein the distance is less than 12 inches in length from the eye lens, and wherein the second optical focusing lens has a second plurality of micro-lenses of a second focal length and second curvature, wherein the second focal length is adjustable and the second curvature is convex.

31. A display apparatus placed at a distance from a human eye, wherein the distance is less than 12 inches in length from the eye lens, and wherein the display apparatus projects a focused image to the eye, the display apparatus comprising:
a display screen that is opaque to surrounding environmental wavelengths of light having a plurality of pixels and sub-pixels arranged in an array to produce an image;
a plurality of aperture openings in the display screen that allow an image of the external environment to pass through the display screen wherein the ratio of apertures to pixels is less than 10:1;
and
an optical focusing lens placed between the display screen and the eye having a plurality of micro-lenses arranged in an array to focus the display screen image to the eye.
